(19) United States
(12) Patent Application Publication
(10) Pub. No.: US 2025/0244127 A1
(43) Pub. Date: Jul. 31, 2025

(54) SENSOR APPARATUS, SENSOR MODULE, INTEGRATED CIRCUIT, INCLINATION ANGLE ESTIMATION METHOD AND AZIMUTH DETECTION METHOD

(71) Applicant: KABUSHIKI KAISHA TOSHIBA, Tokyo (JP)

(72) Inventor: Tazuko TOMIOKA, Kawasaki Kanagawa (JP)

(73) Assignee: KABUSHIKI KAISHA TOSHIBA, Tokyo (JP)

(21) Appl. No.: 19/036,152

(22) Filed: Jan. 24, 2025

(30) Foreign Application Priority Data
Jan. 31, 2024 (JP) 2024-013593

(51) Int. Cl. G01C 19/38; G01C 9/02; G01C 19/00; G01C 23/00; G01P 3/48

(52) U.S. Cl. CPC G01C 19/38; G01C 9/02; G01C 19/005; G01C 23/00; G01P 3/48

(57) ABSTRACT

A sensor apparatus according to the present embodiment incudes: a mechanism configured to rotate a rotation system around a rotation axis and is provided with an accelerometer having an axis that is not parallel to either a plane perpendicular to the rotation axis or the rotation axis; and a processor configured to acquire an acceleration measured by the accelerometer in response to rotation angles of three or more points of the rotation system rotated, separate the acceleration into a first component that follows the rotation of the rotation system and a second component that does not follow the rotation of the rotation system, and estimate an inclination angle of the rotation system based on the first component and the second component.

### CROSS REFERENCE TO RELATED APPLICATIONS

This application is based upon and claims the benefit of priority from the prior Japanese Patent Application No. 2024-013593, filed on Jan. 31, 2024, the entire contents of which are incorporated herein by reference.

### FIELD

The present embodiments relate to a sensor apparatus, a orientation detection apparatus, a sensor module and an inclination angle estimation method.

### BACKGROUND

Methods for detecting the true north generally involve the use of magnetic compasses. However, the Earth's magnetism is very weak, nearby magnetized metal exerts a large effect, and the correct north is often not indicated. The GPS (Global Positioning System) has an optional function of indicating azimuths, but it cannot be used indoors where no line of sight to GPS satellites can be attained.

Methods for precisely estimating the true north without the effect of surrounding buildings include a method of detecting the Earth's rotation by using a gyroscope (see Literature 1: Yongjian Zhang, Bin Zhou, Mingliang Song, Bo Hou, Haifeng Xing and Rong Zhang, “A Novel MEMS Gyro North Finder Design Based on the Rotation Modulation Technique,” Sensors (Switzerland) vol. 17 (5), Article number 973, 2017).

Description will be made by using FIGS. 14A to 14C. FIG. 14A shows a sphere mimicking Earth, and Earth rotates at an angular velocity “ωᵢₑ”. An example of detecting the true north at a position “P” of a black dot will be considered. Axes forming NED (North-East-Down) coordinates at the position of “P” are indicated by arrows. FIG. 14B is a diagram viewing this from right beside in a horizontal plane. The Earth is rotating on an axis in the upward direction in the figure. The position of “P” is at a latitude “L” [rad]. At “P” as well, the angular velocity “ωᵢₑ” appears as rotation in the upward direction in the figure. This rotation is projected onto a rotation axis in the direction of a north-direction vector “North” at a magnitude of “cosL”. That is, when a gyro having an axis in the “North” direction is placed at the position of “P”, the Earth's rotation can be observed with a magnitude of “ωᵢₑ cos L”. FIG. 14C is a diagram viewing “P” from directly upward in the NED coordinate system, that is, the Earth's surface from above. A case will be considered in which an axis of the gyro is not placed at the north but at an angle rotated by “αᵢ” (i=1, 2) from the true north on a horizontal plane. The projection “ωᵢₑ cos L” of the Earth's rotation in the north direction is further projected onto the axis of the gyro at the angle of “αᵢ”, and the angular velocity of the Earth's rotation detected when the gyro axis is placed in each direction is “ωᵢₑ cos L cos αᵢ”. Defining “ωᵢₑ cos L=ωᵢₑm”, it is “ωᵢₑₘ cos α”, and when “α” is rotated one round from 0 to 2π, the angular velocity of the Earth's rotation changes in a sinusoidal wave shape. During the one round of rotation, the highest of the angular velocity of the Earth's rotation is observed when “α” is at the true north.

Therefore, it is possible to detect the true north by placing a gyro with a sensitivity so high that it can measure the Earth's rotation on a rotation stage and detecting an angle of the gyro axis indicating a peak from the waveform of angular velocity obtained by rotating the gyro axis one round on a horizontal plane. Since it detects the Earth's rotation, it is possible to perform detection regardless of radio or magnetic environments.

In order to accurately detect the true north, it is necessary to rotate the gyro axis completely in a horizontal plane. If the rotation stage is inclined to some extent to the east and west about the “North” axis, operation is performed in the same way as if the surface of the rotation stage is placed at a point of a different latitude and longitude where it completely coincides with a horizontal plane. Therefore, the north angle indicates a north direction at the latitude and longitude of a different point where the rotation stage surface coincides with a horizontal plane, not at the longitude of “P”.

Depending on the required accuracy of the true north, if an accuracy below one degree is required, the same degree of horizontality of the rotation stage is required, which cannot be easily achieved.

Regarding this problem, it has been shown that, even if the rotation stage is not placed completely horizontally, an accelerometer having an axis is additionally provided on the rotation stage to detect the direction of gravity and measure inclination, so that it is possible to correct an error that occurs due to the failure of completely horizontal placement (see Literature 1).

Although the inclination of the rotation stage is actually represented by two angles, pitch and roll, with respect to the axis of the gyro or the accelerometer, in order to simplify description, description will be made with one inclination angle of “0” by assuming that the axis of the accelerometer is inclined by “0” with respect to an axis on the rotation stage surface perpendicular to it. When the accelerometer is installed to have an axis parallel to the rotation stage inclined as shown in FIG. 15A and the rotation stage is rotated one round, the projection of gravity onto the axis of the accelerometer also changes in a sinusoidal wave shape. The angle “0” can be obtained from the amplitude of the detected acceleration sine wave.

However, this method has a problem. The accelerometer detects the acceleration in the form of voltage. A voltage obtained by multiplying the acceleration by a coefficient referred to as a scale factor (SF) is detected. An accelerometer formed of MEMS (Micro Electro Mechanical Systems) is highly temperature dependent, and the SF can vary with temperature. There is a limit to calibration, and it is difficult to perform complete correction due to changes over time or the like.

If there is SF variation, the accuracy of the estimated inclination angle is lowered in the above-described method. As shown in FIG. 15B, the component of gravity “G” detected when the axis of the accelerometer is inclined by “θ” is “G sin θ”. It is assumed that there is SF variation, and the detected voltage is “SF₁*G sin θ” at a certain point of time and “SF₂*G sin θ” at another point of time. If the SF at that point of time is not recognized as “SF₂” and the acceleration and thus the inclination angle are calculated by considering it as “SF₁”, it is detected as an angle of “θ′” such that SF₂*G sin θ=SF₁*G sin θ′.

In true north detection (so-called “north findings”), in the worst case, an angle of difference between “θ” and “θ′” directly appears as an error of the true north angle. Therefore, this method is highly dependent on the SF and is not suitable for precise true north detection.

Although it is also conceivable to return to basics of inclination detection and use a two- or three-axis accelerometer, instead of detecting the inclination by rotating the single-axis accelerometer on the rotation stage, this problem is not solved unless the SFs of the multiple axes always coincide with each other or are always known correctly. In addition, the use of multiple axes increases the device cost.

### BRIEF DESCRIPTION OF THE DRAWINGS

FIG. 1 is a diagram illustrating a sensor apparatus for measuring an inclination according to a first embodiment of the present invention;

FIGS. 2A and 2B is a diagram for illustrating effects of the first embodiment of the present invention;

FIG. 3 is a block diagram showing a configuration example of the sensor apparatus for measuring an inclination according to the first embodiment of the present invention;

FIG. 4 is a diagram showing an example of a flow of an inclination estimation method according to the first embodiment of the present invention;

FIG. 5 is a diagram illustrating a sensor apparatus for performing true north detection according to a second embodiment of the present invention;

FIG. 6 is a block diagram showing a configuration example of the sensor apparatus for performing true north detection according to the second embodiment of the present invention;

FIG. 7 is a diagram showing an example of a flow of a true north detection method according to the second embodiment of the present invention;

FIGS. 8A and 8B is a diagram for illustrating a range of “μ” for effective operation of the first or second embodiment of the present invention;

FIGS. 9A and 9B is a diagram for illustrating a range of “μ” for effective operation of the first or second embodiment of the present invention;

FIG. 10 is a diagram showing a layout example of a MEMS integrated circuit according to a third embodiment of the present invention;

FIG. 11 is a diagram showing an example of a sensor module according to a fourth embodiment of the present invention;

FIG. 12 is a diagram showing an example of a true north detection apparatus according to a fifth embodiment of the present invention;

FIG. 13 is a diagram showing an example of a true north detection apparatus according to a sixth embodiment of the present invention;

FIGS. 14A to 14C is a diagram for illustrating a true north estimation method in a prior art; and

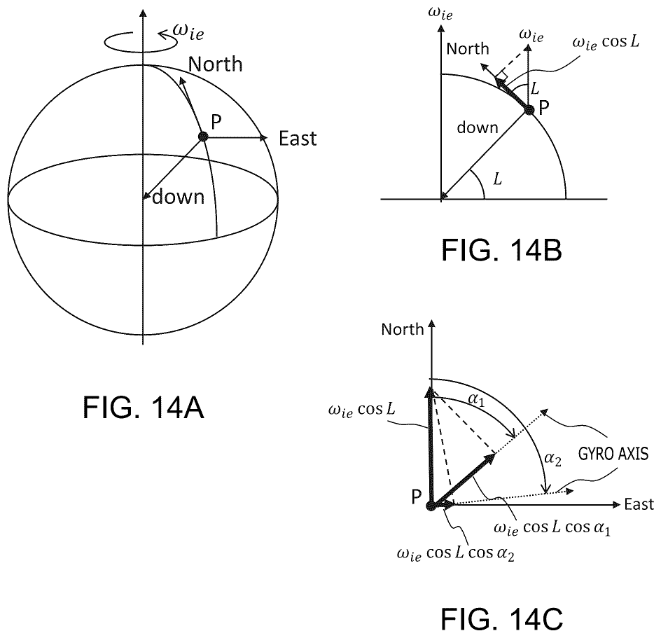

FIGS. 15A and 15B is a diagram for illustrating an inclination estimation method in a prior art.

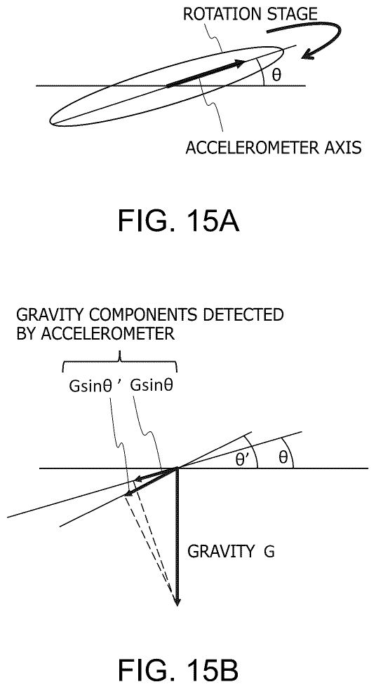

### DETAILED DESCRIPTION

According to one embodiment, a sensor apparatus includes: a mechanism configured to rotate a rotation system around a rotation axis, the rotation system being provided with an accelerometer having an axis that is not parallel to either a plane perpendicular to the rotation axis or the rotation axis; and a processor configured to acquire an acceleration measured by the accelerometer in response to rotation angles of three or more points of the rotation system rotated, separate the acceleration into a first component that follows the rotation of the rotation system and a second component that does not follow the rotation of the rotation system, and estimate an inclination angle of the rotation system based on the first component and the second component.

Embodiments of the present invention will be described by using the drawings. Note that, in the following embodiments, only portions essentially required for the configuration of the embodiments of the present invention are shown, and the illustration and description of portions that are not directly related to the operation of the embodiments of the present invention are omitted.

### First Embodiment

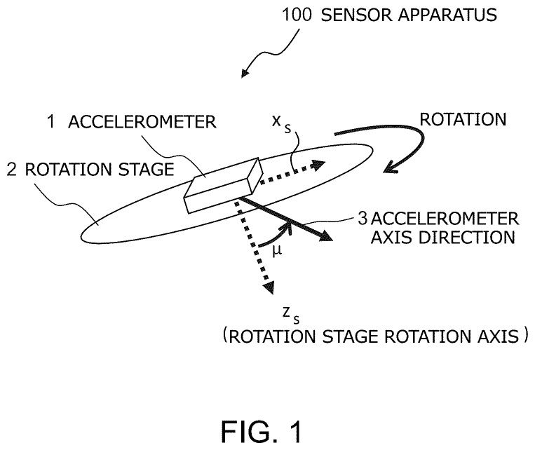

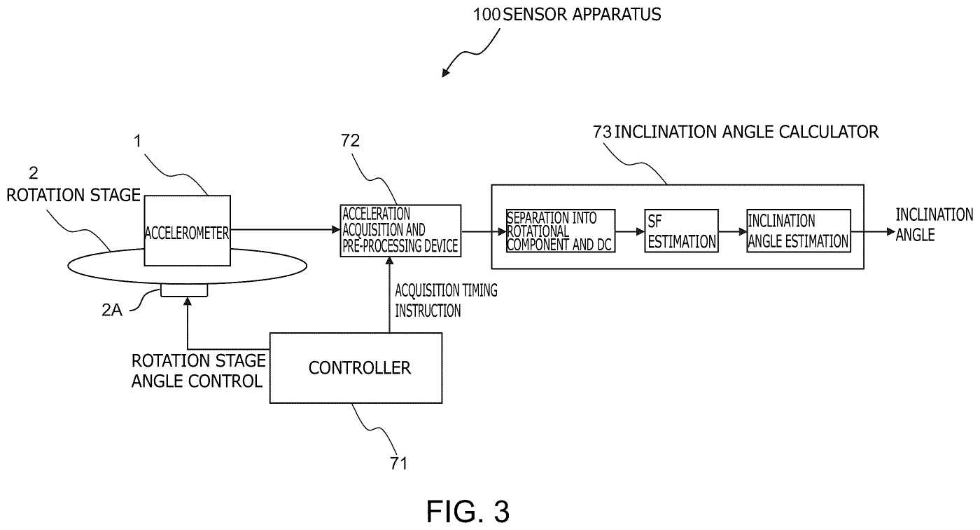

FIG. 1 shows one of the embodiments of the present invention. A sensor apparatus 100 is an apparatus for detecting the inclination of a rotation stage 2, and has the rotation stage 2, an accelerometer 1 and the like. A detailed configuration is shown in FIG. 3, which will be described later. A rotation mechanism of the rotation stage 2, a line for outputting data from the accelerometer 1 and the like are omitted.

The accelerometer 1 is installed on the rotation stage 2. In the figure, the rotation axis of the rotation stage is defined as “zₛ”, and the rotation stage surface is perpendicular to “zₛ”. An axis “xₛ” is defined in a plane perpendicular to “zₛ”. The accelerometer 1 is a single-axis accelerometer, and its detection axis is not “zₛ” nor in a plane perpendicular to “zₛ”, but at an angle intentionally inclined from both of them. In the figure, the axis is in a plane formed by “zₛ” and “xₛ” and is inclined by “μ” from “zₛ”. Hereafter, the axis of the accelerometer inclined by “μ” will be referred to as a “μ” axis. The “μ” axis corresponds to an accelerometer axis direction 3. Note that “xₛ” is actually defined in the direction of a line in which a plane having “zₛ” and the “μ” axis intersects with a plane perpendicular to “zₛ”.

The rotation stage 2 rotates approximately one round or more around “zₛ” as its rotation axis. The rotation is performed in the direction of an arrow in the figure, and may also be in the opposite direction. The rotation is performed approximately one round or more, and there are broadly two ways of rotation and acceleration measurement.

The first one is a method of measuring acceleration while performing rotation, and the second one is a method of performing measurement by repeating measurement at rest→rotation→measurement at rest→rotation. In the first method, rotation is performed at a constant angular velocity. In either method, it is necessary to rotate the accelerometer at least approximately one round or more. This is because the measured acceleration changes in a sinusoidal wave shape with rotation and it is necessary to detect the amplitude and phase of the sinusoidal wave.

For example, four points may be defined at intervals of 90 degrees in one round to perform measurement at 0 degrees→90 degrees→180 degrees→270 degrees. In this case, since there is no need to finally return to 0 degrees, one complete round of rotation is not made. However, rotation is performed to such an extent that the amplitude and phase of the sinusoidal wave can be obtained, that is, approximately one round.

The amplitude and phase of the sinusoidal wave can be obtained by the Fourier transform. According to the Fourier transform and the sampling theorem, if there are at least three points within 360 degrees, the amplitude of the sinusoidal wave can be estimated from measured values. It is not necessarily required that a point of maximum amplitude is included in the measured values.

In an example of three points, measurement may be performed at three points of 0 degrees→120 degrees→240 degrees.

Basically, since the Fourier transform is performed on the measured acceleration, it is not necessarily required to end with one round, and multiple rounds of rotation may be performed. Note that it is not necessary to perform the Fourier transform for all of well-known frequencies. DFT (Discrete Fourier Transform) may be performed to estimate coefficients for specified frequencies, specified phases here, for example, 0 degrees→90 degrees→180 degrees→270 degrees. That is, each measured value is multiplied by “exp(−jα)”, where “α” is its rotation angle, and the results of multiplication of all points are summed.

The acceleration measured by the accelerometer with the “μ” axis can be separated into a component that changes in a sinusoidal wave shape with rotation and a component that does not change with rotation (a DC component). Note that the accelerometer is appropriately calibrated, and a bias component of the accelerometer is removed from the detected DC component for use.

The inclination angle is calculated from the DC component and a quantity containing the phase of the rotational component. Since both of them are separated from a quantity measured by one axis, their scale factors (SFs) always coincide with each other. Therefore, any error dependent on the SFs does not occur.

In the following, this will be specifically described by using equations.

The above description has been made with one inclination angle in order to simplify the description, an inclination is typically defined by two angles, a pitch angle “θ” and a roll angle “γ”. A yaw angle is another angle for defining rotation, which is here a north angle “ϕ”, a deviation from true north.

In the following, a NED (North East Down: X, Y and Z in the order of north, east and down, and for Z-axis rotation, rightward rotation as viewed from above is defined as positive rotation) system is adopted as a global frame. A system having the inclined rotation stage is a sensor frame, and the sensor frame is defined by a right-handed system in which a z axis points downward as in the NED.

Starting from a point where the sensor frame axes coincide with the NED, frame rotation is performed in the order of yaw (north angle) “ϕ”[rad]→pitch “θ”[rad]→roll “γ” [rad]→rotation stage rotation “α” [rad]. Respective rotation matrices “Cₙ¹, C₁², C₂^{b}, C_{b}^{m}” are as follows.

$${C}_{n}^{1} = [ \begin{matrix}cos ϕ & sin ϕ & 0 \\ - sin ϕ & cos ϕ & 0 \\ 0 & 0 & 1\end{matrix} ] \qquad ( 1 )$$

$${C}_{1}^{2} = [ \begin{matrix}cos θ & 0 & - sin θ \\ 0 & 1 & 0 \\ sin θ & 0 & cos θ\end{matrix} ] \qquad ( 2 )$$

$${C}_{2}^{b} = [ \begin{matrix}1 & 0 & 0 \\ 0 & cos γ & sin γ \\ 0 & - sin γ & cos γ\end{matrix} ] \qquad ( 3 )$$

$${C}_{b}^{m} = [ \begin{matrix}cos α & sin α & 0 \\ - sin α & cos α & 0 \\ 0 & 0 & 1\end{matrix} ] \qquad ( 4 )$$

A gravity “fₙ” vector in the NED at a latitude “L” [rad] is defined as follows.

$${f}_{n} = [ \begin{matrix}\begin{matrix}0 \\ 0\end{matrix} \\ g\end{matrix} ] \qquad ( 5 )$$

The letter “g” indicates gravitational acceleration [m/s²] at the latitude “L” [rad].

Gravity components “fₘ” in the sensor frame are as follows.

$${f}_{m} = [ \begin{matrix}{f}_{m x} \\ {f}_{my} \\ {f}_{m z}\end{matrix} ] = {C}_{n}^{m} {f}_{n} = {C}_{b}^{m} {C}_{2}^{b} {C}_{1}^{2} {C}_{n}^{1} {f}_{n} = g [ \begin{matrix}sin γ cos θ sin α - sin θ cos α \\ sin θ sin α + sin γ cos θ cos α \\ cos γ cos θ\end{matrix} ] \qquad ( 6 )$$

In the case of detection with the “μ” axis, representation can be made by composition of the X-axis component “fₘₓ” and the Z-axis component “f_{my}”. An accelerometer bias “E_{aμ}” and an accelerometer SF “S_{aμ}” are introduced to define a measured value “\tilde{f}_{mμ}”. Note that “\tilde{f}_{mμ}” is defined as an acceleration obtained as a result of processing, not a voltage. Therefore, “S_{aμ}” is not the correct SF but is an SF that changes the magnitude of detected acceleration due to an error.

$${\tilde{f}}_{m μ} = {S}_{a μ} g sin μ ( sin γ cos θ sin α - sin θ cos α ) + {S}_{a μ} g cos μ cos γ cos θ + {E}_{a μ} \qquad ( 7 )$$

The first term of the right-hand side is a component dependent on “α”, that is, a component that changes with rotation (a rotational component). The second term and the third term form the DC component. The former rotational component corresponds to a first component parallel to a plane perpendicular to the rotation axis, and the latter DC component corresponds to a second component perpendicular to a plane perpendicular to the rotation axis.

Effects of the accelerometer bias component will be described later. Here, for the time being, an equation for obtaining the inclination angle is derived by assuming that E_{aμ}=0. If the average value of “\tilde{f}_{mμ}” is defined as “B_{μ}” and is removed, there is only a sinusoidal wave-shaped component “\tilde{f}_{mμα}”.

$${\tilde{f}}_{m μ a} = {S}_{a μ} g sin μ ( sin γ cos θ sin α - sin θ cos α ) \qquad ( 8 )$$

This is a sinusoidal wave having phase, which can be defined as “α′cos (α−x′)”. The phase and amplitude can be obtained by the Fourier transform. Specifically, calculation is performed by using the DFT, in which Fourier transform kernels consisting of “exp(−jα)” are generated and a measured value for each value of “α” is multiplied by a corresponding Fourier transform kernel for averaging. The amplitude and phase of a complex number as the result of the DFT are used to obtain the amplitude and phase of the sinusoidal wave mentioned above.

The values of “S_{aμ}”, “θ”, “γ” can be obtained from “a′”, “x′” and “B_{μ}”.

$${S}_{a μ} = 1 / g \sqrt{\frac{{B}_{μ}^{2}}{{cos}^{2} μ} + \frac{{a}^{′ 2}}{{sin}^{2} μ}} , θ = asin ( \frac{- {a}^{′} cos {x}^{′}}{g {S}_{a μ} sin μ} ) , γ = asin ( \frac{{a}^{′} sin {x}^{′}}{g {S}_{a μ} sin μ cos θ} ) \qquad ( 9 )$$

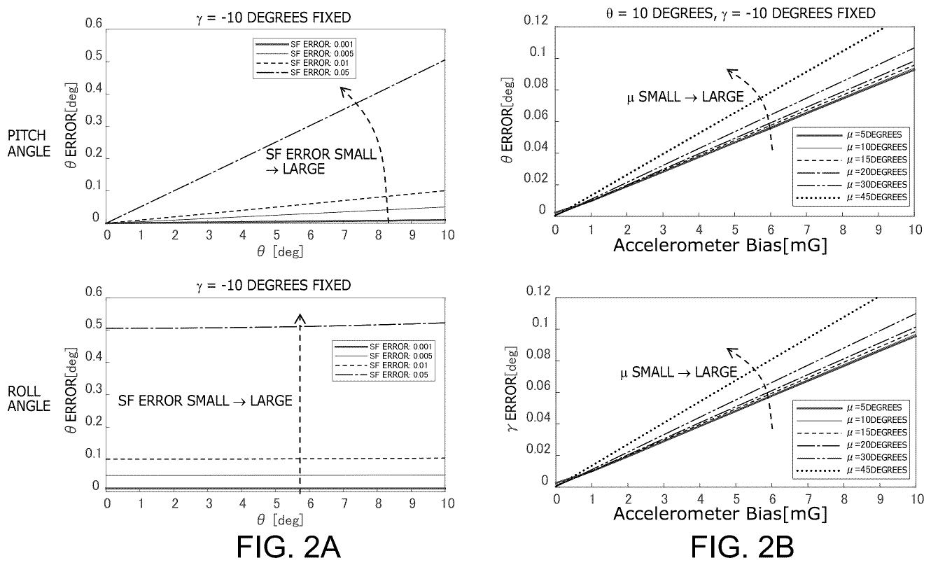

Simulation results of effects of the present embodiment are shown in FIGS. 2A and 2B. FIG. 2A shows a method of the prior art, and FIG. 2B shows the present embodiment. The upper row shows pitch angle errors, and the lower row shows roll angle errors. One round is divided into four to measure the acceleration at intervals of 90 degrees. Noise is added but is very small. In FIG. 2A, the roll angle is fixed to −10 degrees, and the pitch angle “θ” is indicated on the horizontal axis from 0 degrees to 10 degrees. Respective lines are obtained by varying the SF error from 0.001 to 0.05. The error increases when “0” on the horizontal axis is larger and when the scale factor error is larger, and is 0.5 degrees at the maximum.

FIG. 2B shows the present embodiment. In the present embodiment, since there is no effect of the scale factor, the absolute value of the remaining bias of the “μ” axis accelerometer is used as a parameter on the horizontal axis, and a parameter is the “μ” angle. The pitch angle is fixed to 10 degrees and the roll angle is fixed to −10 degrees, which is a condition that corresponds to θ=10 degrees on the horizontal axis in FIG. 2A, that is, a condition under which the error is maximum in FIG. 2A. As described later, an error occurs if a bias that has not been calibrated remains in the accelerometer, and the magnitude of the error changes depending on “μ”. Considering that, if the remaining bias is about 10 mG even with various values of “μ”, the error is at most about 0.15 degrees, and that the remaining bias of a precise accelerometer is typically 1 mG or less, the error is sufficiently small as compared to the error in FIG. 2A when θ=10 degrees.

In this manner, it is possible to obtain an inclination independent of the SF by rotating the single-axis accelerometer.

FIG. 3 shows a block diagram of the sensor apparatus 100 of the present embodiment. The sensor apparatus 100 includes the accelerometer 1, a controller 71, an acceleration acquisition and pre-processing device 72, and an inclination angle calculator 73. The acceleration acquisition and pre-processing device 72 and the inclination angle calculator 73 correspond to a processor that performs processing of the present embodiment. The accelerometer 1 is fixed on the rotation stage 2. The controller 71 indicates an angle to the rotation stage 2 or a rotation mechanism 2A that rotates the rotation stage 2, and provides instructions for acquisition of an acceleration to the acceleration acquisition and pre-processing device 72 in association with the angle of the rotation stage. The acceleration output from the accelerometer 1 is subjected to pre-processing as necessary in the acceleration acquisition and pre-processing device 72. For example, in the case of performing measurement at four angles at intervals of 90 degrees, after the controller 71 causes the rotation stage to rotate and the rotation stage stably comes to rest at each specified angle, the acceleration acquisition and pre-processing device 72 acquires an acceleration for a predetermined period of time when receiving an acceleration acquisition instruction output to the acceleration acquisition and pre-processing device 72 by the controller 71. The acceleration acquisition and pre-processing device 72 performs temperature calibration or the like on the acquired acceleration as necessary, and calculates an average value or a sum value or a low-pass filtered value (hereinafter representatively referred to as an average value) within the period of acquisition. Similar pre-processing is performed on the four angles, and a pre-processed acceleration obtained is output to the inclination angle calculator 73. The inclination angle calculator 73 separates the pre-processed angular velocity into a rotational component and a DC component by means of the above-described algorithm, estimates an SF from these components, and uses the estimated SF to estimate and output inclination angles (a pitch angle and a roll angle). The output inclination angles are input to a display device, another device, a north angle calculator of a true north detection apparatus (so-called “north finder”), a PC or the like, which are not shown, as necessary.

Some or all of the blocks other than the accelerometer 1 may be integrated into the accelerometer module, or may be on the outside of the rotation stage so that acceleration data is retrieved out of the rotation stage for processing through wired or wireless communication.

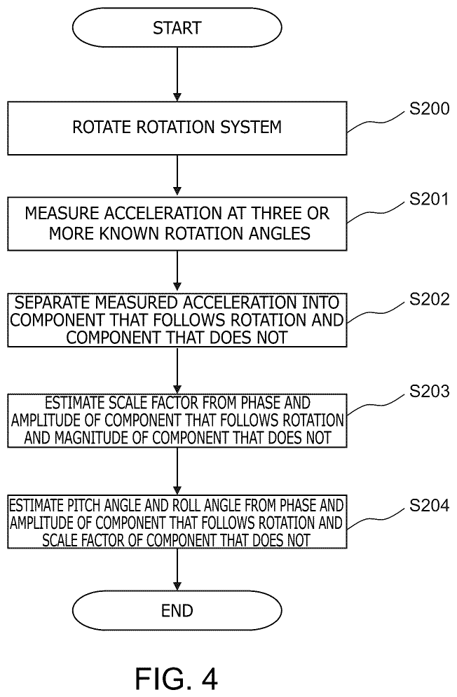

FIG. 4 shows an example of a flow of an inclination estimation method, which is one embodiment of the present invention. The controller 71 indicates an angle to the rotation stage (S200), and provides instructions for acquisition of an acceleration at three or more known rotation angles (S201). The acceleration output from the accelerometer 1 is subjected to pre-processing as necessary in the acceleration acquisition and pre-processing device 72. The inclination angle calculator 73 separates the pre-processed acceleration into a rotational component and a DC component by means of the above-described algorithm (S202), estimates an SF from these components (S203), and uses the estimated SF to estimate and output inclination angles (a pitch angle and a roll angle) (S204).

Note that the rotation stage in its literal sense is not actually required for practicing the present invention. A “stage” is not necessarily required, and a mechanism other than the rotation stage may be used as long as it is a mechanism that rotates the accelerometer on the “zₛ” axis as its rotation axis. The accelerometer 1 is assumed to be formed of MEMS, but may be of a different material such as quartz crystal.

Note that “a” is continuous in the case of performing measurement while performing rotation, and “a” is discrete in the case of repeating measurement at rest and rotation. In present times, values are always discretely output in correspondence with an ODR (Output Data Rate) even in continuous measurement, and therefore there is no difference in equations between the two methods for clinometer applications. On the other hand, for the north finder, which will be described later, in the case of performing measurement while performing rotation, unless the gyro axis is completely orthogonal to the rotation axis, the rotation of the rotation stage leaks to the gyro axis and add to the Earth's rotation, lowering the phase detection accuracy. In the case of performing measurement while performing rotation, a very precise rotation stage is required.

### Second Embodiment

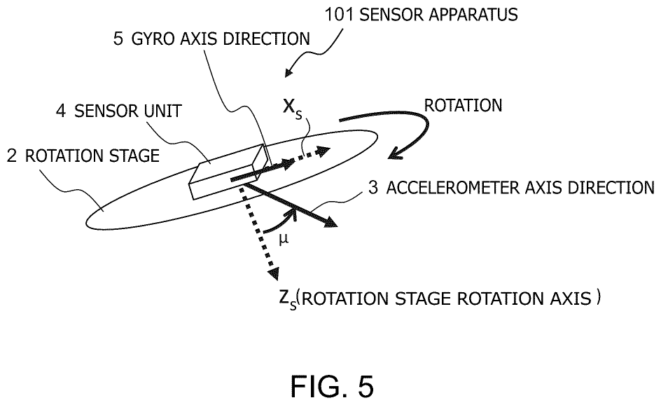

Next, as a second embodiment, a sensor apparatus for performing true north detection including the clinometer described above will be described by using FIG. 5.

In FIG. 5, a sensor unit 4 including a gyroscope and an accelerometer is placed on the rotation stage 2. Of course, it is not necessary that the gyro and the accelerometer are included in one module, and separate modules may be placed on the rotation stage 2.

The axis of the accelerometer is similar to that in FIG. 1. The axis of the gyro coincides with the “xₛ” axis. In effect, a direction 5 of the axis of the gyro is defined as the “xₛ” axis. The principles of the north findings are as described for the prior art. Similar to inclination measurement, the rotation stage 2 is rotated approximately one round or more to measure an angular velocity at each rotation angle. The magnitude of the angular velocity changes in a sinusoidal wave shape in association with changes in the angle of the gyro axis. If there is no inclination, an angle of the axis at which a maximum value thereof is indicated is the north angle. Of course, since an angle at which a minimum value is indicated is at the true south, the minimum value may also be detected.

Assuming that the inclination is not 0 degrees, a north angle correction method by means of the inclination obtained by the clinometer will be described. Note that, in the method of Literature 1, an error also occurs due to the SF of the gyro in the north angle correction, but in accordance with the following method, there is no effect of the SF error of the gyro.

An Earth's rotation “ωᵢₑⁿ” vector in the NED at a latitude “L” [rad] is defined as follows.

$${ω}_{i e}^{n} = {ω}_{ie} [ \begin{matrix}cos L \\ 0 \\ - sin L\end{matrix} ] \qquad ( 10 )$$

Earth's rotation components ωᵢₑₘ transformed into the sensor frame are as follows, similar to the case of the accelerometer.

$${ω}_{iem} = [ \begin{matrix}{ω}_{iemx} \\ {ω}_{iemy} \\ {ω}_{iemz}\end{matrix} ] = {C}_{n}^{m} {ω}_{ie}^{n} = {C}_{b}^{m} {C}_{2}^{b} {C}_{1}^{2} {C}_{n}^{1} {ω}_{ie}^{n} \qquad ( 11 )$$

The “xₛ”-axis component of ωᵢₑₘ corresponding to the axis of the gyro is as follows.

$${ω}_{iemx} = {ω}_{ie} \{ sin α [ cos L ( - cos γ sin ϕ + sin γ sin θ cos ϕ ) - sin L ( sin γ cos θ ) ] + cos α [ cos L cos θ cos ϕ + sin L sin θ ] \} \qquad ( 12 )$$

Equations for the other axes are omitted due to their complexity. A gyro bias “E_{gx}” and a coefficient “S_{gx}” that changes the magnitude of the detected angular velocity due to the SF error are provided to this to generate a measured value “\tilde{ω}ᵢₑₘₓ”.

$${\tilde{ω}}_{iemx} = {S}_{gx} {ω}_{iemx} + {E}_{gx} \qquad ( 13 )$$

Since “ωᵢₑₘₓ” changes in association with “α” in a sinusoidal wave shape, the north angle can be obtained from its phase. Here, before performing inclination correction, calculation is performed to such a degree that a north angle including the inclination error can be obtained, so that the effect of the gyro SF can be eliminated. Since the north angle obtained here includes an error due to inclination, correction is required. The method for obtaining the phase is similar to that described for the acceleration, and it is calculated from the four-quadrant arctangent of the ratio of the real part and imaginary part of a complex number obtained by the DFT. For inclination correction, estimation of a north angle (phase), which is not correct, is not performed here, and the real part and the imaginary part, which are antecedent to it, as well as its ratio (phase calculation parameter) “R” are used to perform estimation as follows. When the ratio is obtained, the SF effect is eliminated. In the following, description will be made in order.

Defining a unit vector in the NED system corresponding to the Earth's axis toward the north as “v=[v₁v₂v₃]^{T}”, it is as follows.

$$ν = [ \begin{matrix}{v}_{1} \\ {v}_{2} \\ {v}_{3}\end{matrix} ] = [ \begin{matrix}cos L \\ 0 \\ - sin L\end{matrix} ] \qquad ( 14 )$$

In the NED system, v₂=0. An element of a rotation matrix “c₁^{b}=c₂^{b}c₁²?” by the inclination “θ” and “γ” obtained by the inclination estimation is defined as “mᵢⱼ” (“i” indicates the row and “j” indicates the column). Defining the real part of the DFT result as “X” and the imaginary part as “Y”, the ratio “R” corresponding to “tan” of the direction of the north angle indicated by the rotation stage is equal to “−Y/X”. Note that, if the sensor frame is used for reference, a value obtained by rendering the phase of the sinusoidal waveform of the angular velocity negative is the north angle, and thus “R” is defined by giving a minus sign to “Y/X”. The value “R” is obtained as follows from the x and y components of a vector obtained by rotating equation (14) according to equations (1), (2) and (3).

$$R = \frac{{m}_{21} ( {v}_{1} cos ϕ + {v}_{2} sin ϕ ) + {m}_{22} ( - {v}_{1} sin ϕ + {v}_{2} cos ϕ ) + {m}_{23} {v}_{3}}{{m}_{11} ( {v}_{1} cos ϕ + {v}_{2} sin ϕ ) + {m}_{12} ( - {v}_{1} sin ϕ + {v}_{2} cos ϕ ) + {m}_{23} {v}_{3}} \qquad ( 15 )$$

This is organized by “cos ϕ” and “sin ϕ” as follows.

$$( R ( {m}_{11} {v}_{1} + {m}_{12} {v}_{2} ) - ( {m}_{21} {v}_{1} + {m}_{22} {v}_{2} ) ) cos ϕ + ( R ( {m}_{11} {v}_{2} - {m}_{12} {v}_{1} ) - ( {m}_{21} {v}_{2} - {m}_{22} {v}_{1} ) ) sin ϕ + {v}_{3} ( {Rm}_{13} - {m}_{23} ) = 0 \qquad ( 16 )$$

Defining this as “A cos ϕ+B sin ϕ+C=0”, it can be solved for “sin₂ ϕ”, obtaining the following equations.

$$sin ϕ = \frac{- 2 BC \pm \sqrt{4 {B}^{2} {C}^{2} - 4 ( {B}^{2} + {A}^{2} ) ( {C}^{2} - {A}^{2} )}}{2 ( {B}^{2} + {A}^{2} )} , \qquad ( 17 )$$

$$cos ϕ = \frac{- 2 AC \pm \sqrt{4 {A}^{2} {C}^{2} - 4 ( {B}^{2} + {A}^{2} ) ( {C}^{2} - {B}^{2} )}}{2 ( {B}^{2} + {A}^{2} )}$$

Since the equation is squared for solving it, an ambiguity occurs. This is resolved by the following algorithm. When “R” is obtained, even though it is primarily necessary to solve it by a four-quadrant arctangent, it is only an arctangent. Therefore, signs before obtaining the ratio are used.

The sign “S_{X}” of “X” and the sign “S_{y}” of “−Y” are to be obtained. The signs “S_{X}” and “S_{y}” are plus or minus.

From “mᵢⱼ” calculated by using “θ” and “γ” obtained by the inclination estimation, “v” obtained from the latitude, and “R”, equation (17) is used to obtain candidates for “sin ϕ” and “cos ϕ”, and candidates for which the respective signs of the denominator and numerator of equation (15) coincide with “S_{X}” and “S_{y}”, respectively, are selected. From the selected values of “sin ϕ” and “cos ϕ”, the north angle is obtained by the four-quadrant arctangent.

In this manner, it is possible to estimate an inclination-corrected north angle that is not dependent on either the accelerometer SF or the gyro SF.

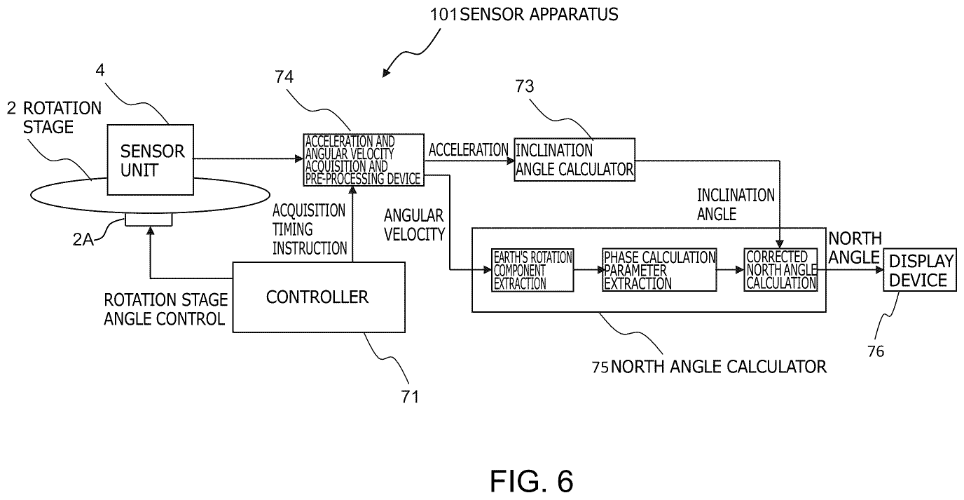

FIG. 6 shows a block diagram of a sensor apparatus 101 of the present embodiment. The sensor apparatus 101 includes a sensor unit 4, a controller 71, an acceleration and angular velocity acquisition and pre-processing device 74, an inclination angle calculator 73, and a north angle calculator 75. The acceleration and angular velocity acquisition and pre-processing device 74, the inclination angle calculator 73 and the north angle calculator 75 correspond to a processor that performs processing of the present embodiment. The sensor unit 4 is fixed on a rotation stage 2. The controller 71 indicates an angle to the rotation stage 2 or a rotation mechanism 2A that rotates the rotation stage 2, and provides instructions for acquisition of an acceleration and an angular velocity to the acceleration and angular velocity acquisition and pre-processing device 74 in association with the angle of the rotation stage. The acceleration and angular velocity output from the sensor unit 4 is subjected to pre-processing as necessary in the acceleration and angular velocity acquisition and pre-processing device 74. For example, if measurement is performed on the rotation stage at four angles at intervals of 90 degrees, after the rotation stage stably comes to rest at each angle, the acceleration and angular velocity acquisition and pre-processing device 74 acquires an acceleration and an angular velocity for a predetermined period of time when receiving an acceleration and angular velocity acquisition instruction from the controller 71. Each one is subjected to temperature calibration or the like as necessary, and an average value or the like within that period of time is calculated. Similar pre-processing is performed on the four angles, and a pre-processed acceleration and pre-processed angular velocity obtained are output to the inclination angle calculator 73 and the north angle calculator 75, respectively. The inclination angle calculator 73 estimates inclination angles (a pitch angle and a roll angle). The north angle calculator 75 extracts an Earth's rotation component from the input pre-processed angular velocity by processing similar to the Fourier transform described above and calculates the north angle (in the case of a method of performing inclination correction after completely obtaining a pre-correction north angle) or extracts a phase calculation parameter antecedent to it. Since the estimated inclination angles (pitch angle and roll angle) are input from the inclination angle calculator 73, these inclination angles and the phase calculation parameter are used to calculate and output an inclination-corrected north angle. The output north angle is input to a display device 76 or, as necessary, another device, PC or the like, which are not shown.

The blocks other than the sensor unit 4 may be on the outside of the rotation stage so that acceleration and angular velocity data is retrieved out of the rotation stage for processing through wired or wireless communication, or some or all of them may be integrated into the sensor unit 4.

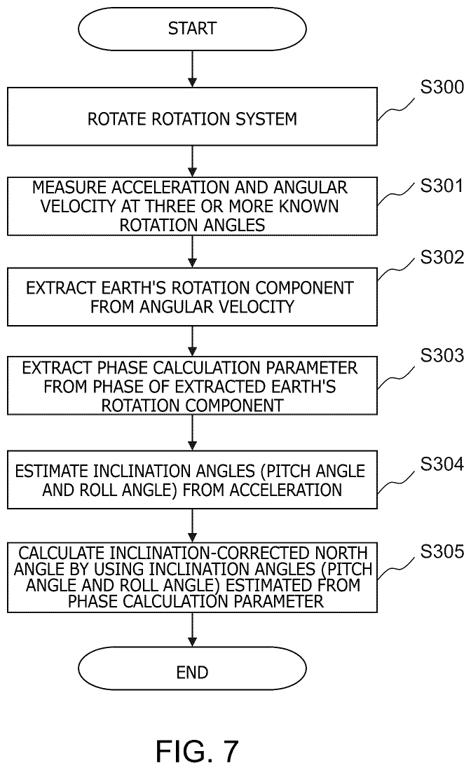

FIG. 7 shows an example of a flow of a true north detection method, which is one embodiment of the invention. The controller 71 indicates an angle to the rotation stage (S300), and provides instructions for acquisition of an acceleration and an angular velocity at three or more known rotation angles (S301). The acceleration and angular velocity output from the sensor unit 4 is subjected to pre-processing as necessary in the acceleration and angular velocity acquisition and pre-processing device 74. A pre-processed acceleration and pre-processed angular velocity obtained are output to the inclination angle calculator 73 and the north angle calculator 75, respectively. The north angle calculator 75 extracts an Earth's rotation component from the input pre-processed angular velocity by processing similar to the Fourier transform described above (S302), and extracts a phase calculation parameter from the phase of the extracted rotation component (S303). The inclination angle calculator 73 estimates inclination angles (a pitch angle and a roll angle) from the acceleration (S304). The north angle calculator 75 uses the phase calculation parameter and the estimated inclination angles (pitch angle and roll angle) to calculate and output an inclination-corrected north angle (S305).

Next, an appropriate angle of “μ” will be described.

In the above description, the bias “E_{aμ}” of the accelerometer is assumed to be 0. However, a MEMS accelerometer in particular is difficult to calibrate such that the bias is 0 on any condition, and it often has a non-zero value. In the present embodiment and the first embodiment, an output of the accelerometer having an oblique axis is separated into a component that changes with rotation and a component that does not change to estimate an inclination. If the accelerometer has a bias, it cannot be distinguished from the component that does not change with rotation, that is, “B_{μ}” in equation (9), and “B_{μ}” is increased or decreased by the bias.

Therefore, by decreasing “μ” and increasing “B_{μ}”, it is possible to reduce the effect of the bias “E_{aμ}” remaining even after the calibration. On the other hand, if “μ” is decreased, the amplitude of the sinusoidal shaped component “\tilde{f}_{mμα}” is decreased by “sin μ”. Since the measured value contains a noise, the accuracy of “a′”, “cos x′” and “sin x′” calculated from the sinusoidal shaped component is lowered, and the error also increases.

As described above, there is an optimal value of “μ”. In the following, that value will be apparent.

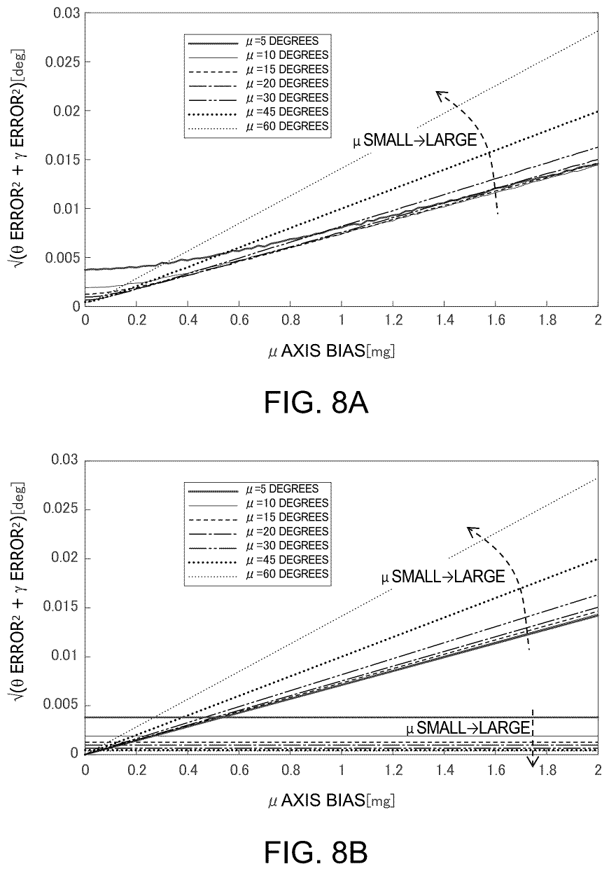

Assuming that the pitch angle and the roll angle are both 5 degrees, a total estimated angle error, that is, (“θ” error\hat{ }2+“γ” error\hat{ }2)^{1/2} [deg] is plotted with respect to the bias that is not removed by using “μ” as a parameter, as shown in FIG. 8A. Note that it is assumed that the noise “σ” is 0.0069 [m/s²] and is filtered by a low-pass filter corresponding to a Nyquist frequency determined by a sampling frequency. That is, it is assumed that the noise is a Gaussian noise and is independent for each sample.

The number of samples “n” used for estimation is 60000. In the estimation theory, the effective noise decreases in inverse proportion to the square root of the number of samples. In this example, it is “σ/√n”. Note that, if a low-pass filter with a cut-off frequency that is much lower than the Nyquist frequency is used, the degree of decrease in the effective noise with respect to the number of samples is decreased, and it becomes greater than “σ/√n”. Considering that fact, the effective noise for the “n” samples is defined as “σₑ”. In the example of FIG. 8A, σ/√n=2.8*10⁻⁵ [m/s²], but this becomes larger when the cut-off frequency is lower.

In FIG. 8A, the error is larger when “μ” is smaller in the vicinity of 0 on the horizontal axis, but gradually as the value on the horizontal axis increases, the error is larger when “μ” is larger.

If the bias is 0, the error is determined only by the noise, and its RMSE (Root Mean Square Error) [rad] is as follows.

$${e}_{n} = \frac{2 {σ}_{e}}{{gS}_{a μ} sin μ} \qquad ( 18 )$$

On the other hand, if the effect of the bias error is so large that the effect of the noise can be ignored, the RMSE is as follows.

$${e}_{b} = \frac{{E}_{a μ} \sqrt{{θ}^{2} + {γ}^{2}}}{{gS}_{a μ} cos μ} \qquad ( 19 )$$

These are plotted as shown in FIG. 8B. A horizontal straight line is “eₙ”, which is determined by the noise, and a straight line with an ascending slope is “e_{b}”, which is dependent on the bias. FIG. 8A shows values of the square root of the sum of the squares of these.

As can be seen from FIG. 8A, the optimal value of “μ” changes with the value of the bias. Of course, it also changes with the effective noise value and the expected inclination. If the purpose of use is north findings, use environments can be presumed in general. It is assumed that the expected remaining bias is 1 [mg] and “\sqrt{θ²+γ²}” changes from 0.1 degrees to 20 degrees.

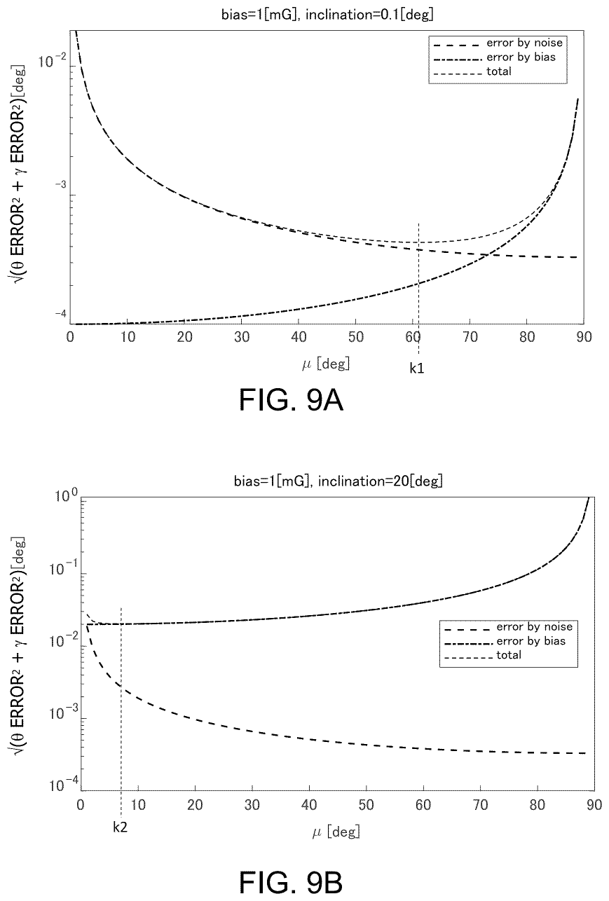

The total error (“θ” error \hat{ }2+“γ” error \hat{ }2)^{1/2} [deg] when the remaining bias is 1 [mg] is shown in FIG. 9A for the case of 0.1 degrees and in FIG. 9B for the case of 20 degrees. The horizontal axis indicates the angle of “μ”, a broken line indicates an error by the noise, a dot-and-dash line indicates an error by the remaining bias, and a red line indicates the total (the square root of the sum of the squares) thereof. In any case, there is a value of “μ” at which the error is minimum. In the example of FIG. 9A, the value of “μ” at which the error is minimum, i.e., “k1” is 61 degrees. In the example of FIG. 9B, the value of “μ” at which the error is minimum, i.e., “k2” is 7 degrees.

Note that if there is no inclination, there is no local minimum point, and it is minimum at 90 degrees. However, completely horizontal placement is actually impossible, and therefore an expected value of an inclination due to an installation error in the case of horizontal placement is set as a minimum value. Here, it is assumed to be 0.1 degrees. In addition, it is assumed that the maximum value of the inclination angle is 20 degrees as an operating condition of the apparatus.

Although the optimal value of “μ” changes according to conditions, the optimal value can be assumed according to usage conditions as described above, and thus the optimal value may be set within a range of the usage conditions.

Note that “S_{aμ}” and “g” are common to “eₙ” and “e_{b}”, and therefore have no effect on the local minimum value. In addition, since the square root is a monotonously increasing function, the square root is not needed to calculate the local minimum value. Therefore, defining an expected inclination angle “n” as follows:

$$η = \sqrt{{θ}^{2} + {γ}^{2}} \qquad ( 20 )$$

It is required to obtain a value of “μ” at which the following value “C” is a local minimum.

$$C = {( \frac{2 {σ}_{e}}{sin μ} )}^{2} + {{η}^{2} ( \frac{{E}_{a μ}}{cos μ} )}^{2} \qquad ( 21 )$$

The range of “η” is limited in an expected range as described above, and “μ” is set to be included in it. In the examples of FIG. 9A and FIG. 9B, the assumed minimum value of the inclination angle of the rotation system (defined as “η₁”) is 0.1 degrees, and the assumed maximum value of the inclination angle of the rotation system (defined as “η₂”) is 20 degrees. A first value that is a value of “μ” that gives a local minimum value of “C” in the case of “n₁” is 61 degrees, and a second value that is a value of “μ” that gives a local minimum value of “C” in the case of “η₂” is 7 degrees. Therefore, “μ” is set within a range from 7 degrees to 61 degrees.

In this manner, it is possible to perform inclination estimation with a small estimation error.

### Third Embodiment

Another embodiment of the present invention will be described. This is an embodiment relating to a MEMS integrated circuit in which a gyroscope for performing true north detection and an accelerometer with an oblique axis are integrated into a single chip.

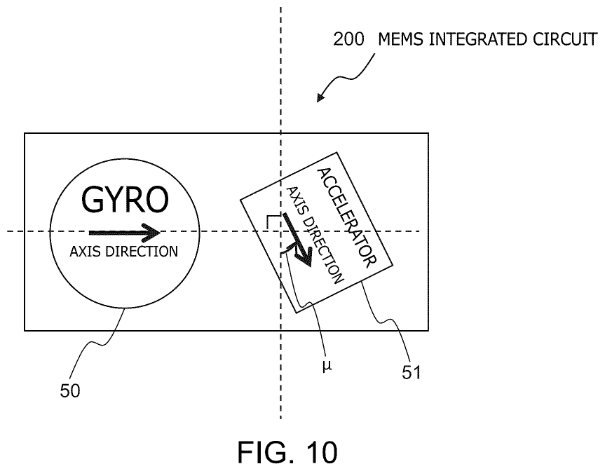

The embodiment is shown in FIG. 10. Only the positions and the orientations of axes of a gyro 50 and an accelerometer 51 are shown. Of course, in actuality, a mass constituting the sensor, their control circuits, circuits for detection of physical quantities and the like are mounted, but they are not related to the essence of the present invention and are omitted.

In a MEMS integrated circuit 200, the single-axis gyro 50 and the single-axis accelerometer are integrated into a single chip. The axis of the gyro 50 is horizontal in the figure, and the axis of the accelerometer 51 is oriented to a direction inclined by “π/2−μ” [rad] with respect to the direction of the axis of the gyro 50. That is, the gyro 50 and the accelerometer 51 are arranged in such a layout that the axis of the accelerometer 51 is at the angle of “μ” with respect to a direction (indicated by a vertical broken line in the figure) perpendicular to the direction of the axis of the gyro 50, indicated by a horizontal broken line in the figure.

Even if a gyro and an accelerometer in separate modules or chips are used and arranged to form an appropriate angle to each other at the time of mounting, a mounting error occurs. By performing single-chip integration as in the present embodiment, the angle of “μ” can be accurately determined by the IC design layout, and manufacture can be performed in the same way. Of course, deviations cannot be completely eliminated, but the error can be made much smaller than if a gyro and an accelerometer that are separate from each other are mounted to have the angle of “μ”. The error in the angle of “μ” has a large effect on the magnitudes of the component that follows rotation and the component that does not, which are important to estimate the inclination. Therefore, it is very important that mounting can be performed to achieve an intended value of “μ”. According to the present embodiment, it is possible to achieve an accurately designed angle.

### Fourth Embodiment

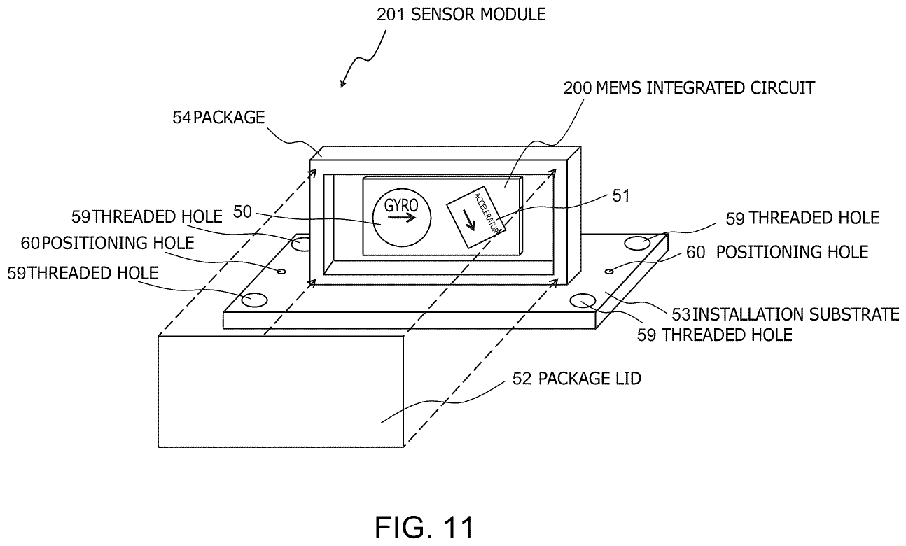

The following embodiment relates to a package mounting form of the MEMS integrated circuit of FIG. 10. FIG. 11 shows an embodiment of a sensor module 201 in which the MEMS integrated circuit 200 is mounted in a package 54. The single-chip integrated IC is installed such that the axis of the accelerometer finally has the angle of “μ” with respect to the rotation axis of the rotation stage. Thus, it is necessary to mount it in a package that is easy to install to the rotation stage. In FIG. 11, the package 54 is installed perpendicularly to an installation substrate 53, and the MEMS integrated circuit 200 is mounted in it. The MEMS integrated circuit 200 is installed perpendicularly to the installation substrate 53. In addition, installation is performed such that the axis of the gyro 50 is parallel to the surface of the installation substrate.

A driving circuit and a data output circuit, as well as a circuit for performing true north detection processing, a battery and the like of the gyro and the accelerometer may be mounted in the package 54, but are not shown in the figure.

After the MEMS integrated circuit 200 is mounted, the package 54 is sealed by a package lid 52. At that time, the inside is vacuum sealed or filled with nitrogen, an inert gas or the like, as necessary.

In the figure, threaded holes 59 are arranged at four corners of the installation substrate 53 so that screws pass therethrough for installation to threaded holes of the rotation stage with the screws. The bottom surface of the installation substrate 53, in particular the bottom surface at portions where the threaded holes are arranged is manufactured with a high degree of parallelism.

The installation substrate 53 further has positioning holes 60. The hole is close to a perfect circle and processed to have an inner surface with little irregularities. The rotation stage also has similar holes, and a pin with a size suitable to the hole is used to align the orientations of the rotation stage and the sensor module.

Note that the way of installation to the rotation stage is not limited to this, and the rotation stage may have a clamp-like component so that fixation to the rotation stage is performed by the clamp.

In this manner, it is possible to precisely install the accelerometer having the oblique axis.

### Fifth Embodiment

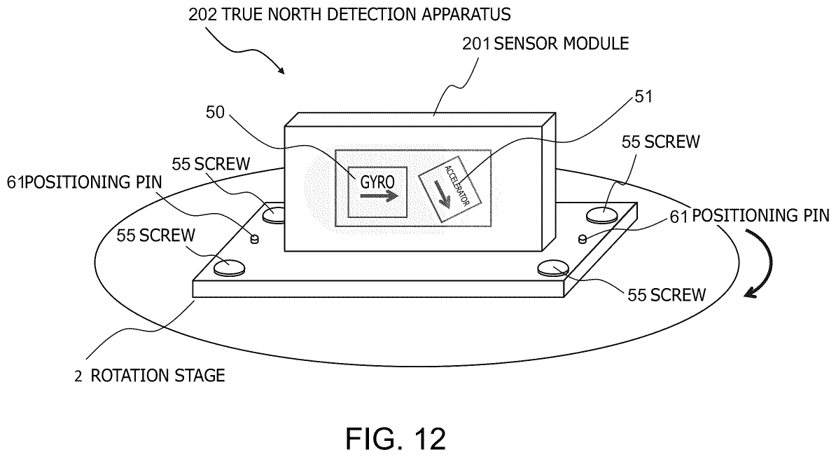

Next, an embodiment of a true north detection apparatus (north finder) 202 in which the sensor module 201 is installed to the rotation stage 2 will be described by using FIG. 12.

The sensor module 201 is installed to the rotation stage 2 by means of screws 55. The rotation stage surface, at least at several (four in the figure) portions for installing the screws, is formed to have a high degree of parallelism so as to reduce errors from set values of the angles of the axes of the gyro 50 and the accelerometer 51. In addition, it is installed to the rotation stage in a correct orientation by positioning pins 61 as described above.

The rotation stage 2 has a rotation mechanism, which is not shown. The rotation stage 2 is operated by the rotation mechanism to rotate at a constant velocity or to move to a specified angle and stop. In the case of a method in which the rotation stage rotates and stops and measurement is performed at rest, the rotation is performed such that an angle at which it comes to rest has a sufficiently small error relative to a set angle or has an error that is known.

A true north angle is detected in the above-described method from outputs of the gyro 50 and the accelerometer 51 at each rotation angle.

In this manner, it is possible to perform precise true north detection by means of a MEMS sensor with a small number of axes.

The shapes of the rotation stage and the rotation object are not necessarily required to be circular.

### Sixth Embodiment

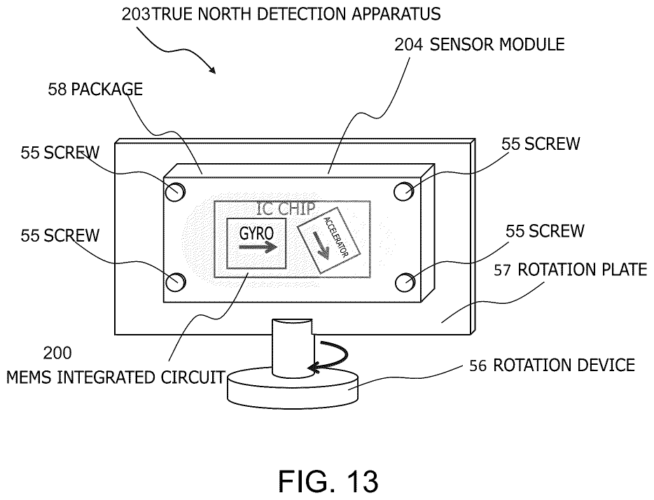

FIG. 13 shows another embodiment of the true north detection apparatus, which is an example in which no rotation stage is used. A true north detection apparatus 203 has a rotation device 56 having a rotation mechanism integrated therein, and a rotation plate 57 is installed to the rotation device 56. The rotation plate 57 provides a module installation surface that is sufficiently parallel to a rotation axis of the rotation device 56, which is not shown.

In a sensor module 204, the MEMS integrated circuit 200 is mounted in a package 58 as in the case of FIG. 11, but the package 58 has no installation substrate in particular and is directly installed to the rotation plate 57 by means of the screws 55. At least surfaces of the package 58 and the rotation plate 57 in contact with each other via the screws are formed to be sufficiently parallel. A positioning hole, a pin and the like may be provided such that the axis of the gyro is perpendicular to the rotation axis. These are mounted on a surface on which the rotation plate 57 and the package 58 are in contact with each other and are not shown in the figure.

North finding procedures are as described above.

In this manner, it is possible to perform precise true north detection by means of a MEMS sensor with a small number of axes.

Note that the present invention is not limited to the embodiments as described above, and can be embodied by modifying components without departing from its spirit at the implementation stage. In addition, various inventions can be formed by appropriate combinations of a plurality of components disclosed in the above-described embodiments. For example, some components may be deleted from all the components shown in the embodiments. Furthermore, components from different embodiments may be appropriately combined.

The embodiments of the present invention can also be configured as follows.

### CLAUSES

Clause 1. A sensor apparatus comprising:
   a mechanism configured to rotate a rotation system around a rotation axis, the rotation system being provided with an accelerometer having an axis that is not parallel to either a plane perpendicular to the rotation axis or the rotation axis; and
   a processor configured to acquire an acceleration measured by the accelerometer in response to rotation angles of three or more points of the rotation system rotated, separate the acceleration into a first component that follows the rotation of the rotation system and a second component that does not follow the rotation of the rotation system, and estimate an inclination angle of the rotation system based on the first component and the second component.
Clause 2. The sensor apparatus according to clause 1, wherein
   the first component is a component that is parallel to the plane perpendicular to the rotation axis, and the second component is a component that is perpendicular to the plane.
Clause 3. The sensor apparatus according to clause 1, wherein
the rotation system is provided with a gyroscope having an axis parallel to the plane perpendicular to the rotation axis of the rotation system, and
the processor is configured to acquire an angular velocity measured by the gyroscope in response to rotation angles of three or more points of the rotation system rotated, and estimate an azimuth of a particular orientation based on the angular velocity and the estimated inclination angle of the rotation system.
Clause 4. The sensor apparatus according to clause 3, wherein the particular orientation is a true north or a true south.
Clause 5. The sensor apparatus according to any one of clauses 1 to 4, wherein
   an angle formed by the axis of the accelerometer and the rotation axis is a value between a first value and a second value, the first value being a value of “μ” that gives a local minimum value of

$$“ C = {( \frac{2 {σ}_{e}}{sin μ} )}^{2} + {{η}_{1}^{2} ( \frac{{E}_{a μ}}{cos μ} )}^{2} ”$$

and the second value being a value of “μ” that gives a local minimum value of

$$“ C = {( \frac{2 {σ}_{e}}{sin μ} )}^{2} + {{η}_{2}^{2} ( \frac{{E}_{a μ}}{cos μ} )}^{2} ” ,$$

wherein
   “η₁” is an expected minimum value of the inclination angle of the rotation system,
   “η₂” is an expected maximum value of the inclination angle of the rotation system,
   “σₑ” is an effective noise of the accelerometer, and
   “E_{aμ}” is an expected remaining bias of the accelerometer.
Clause 6. The sensor apparatus according to clause 5, wherein
   the first value is 61 degrees, and
   the second value is 7 degrees.
Clause 7. An integrated circuit provided on the sensor apparatus according to clause 6, wherein the gyroscope and the accelerometer are integrated into a single chip.
Clause 8. A sensor module comprising:
   a package in which the integrated circuit according to clause 7 is provided, and
   a mechanism capable of attaching the package to the rotation system.
Clause 9. An inclination estimation method comprising:
   rotating a rotation system around a rotation axis, the rotation system being provided with an accelerometer having an axis that is not parallel to either a plane perpendicular to the rotation axis or the rotation axis;
   acquiring an acceleration measured by the accelerometer in response to rotation angles of three or more points of the rotation system rotated; and
   separating the acceleration into a first component that follows the rotation of the rotation system and a second component that does not follow the rotation of the rotation system, and estimate an inclination angle of the rotation system based on the first component and the second component.
Clause 10. An orientation detection method comprising:
   rotating a rotation system on which a gyroscope and an accelerometer are provided around a rotation axis, the gyroscope having an axis parallel to a plane perpendicular to the rotation axis of the rotation system, and the accelerometer having an axis that is not parallel to either the plane perpendicular to the rotation axis or the rotation axis;
   acquiring, in response to rotation angles of three or more points of the rotation system rotated, an angular velocity measured by the gyroscope and an acceleration measured by the accelerometer;
   separating the acceleration into a first component that follows the rotation of the rotation system and a second component that does not follow the rotation of the rotation system;
   estimating an inclination angle of the rotation system based on the first component and the second component; and
   estimating an azimuth of a particular orientation based on the angular velocity and the estimated inclination angle of the rotation system.

1. A sensor apparatus comprising:
a mechanism configured to rotate a rotation system around a rotation axis, the rotation system being provided with an accelerometer having an axis that is not parallel to either a plane perpendicular to the rotation axis or the rotation axis; and
a processor configured to acquire an acceleration measured by the accelerometer in response to rotation angles of three or more points of the rotation system rotated, separate the acceleration into a first component that follows the rotation of the rotation system and a second component that does not follow the rotation of the rotation system, and estimate an inclination angle of the rotation system based on the first component and the second component.

2. The sensor apparatus according to claim 1, wherein
the first component is a component that is parallel to the plane perpendicular to the rotation axis, and the second component is a component that is perpendicular to the plane.

3. The sensor apparatus according to claim 1, wherein
the rotation system is provided with a gyroscope having an axis parallel to the plane perpendicular to the rotation axis of the rotation system, and
the processor is configured to acquire an angular velocity measured by the gyroscope in response to rotation angles of three or more points of the rotation system rotated, and estimate an azimuth of a particular orientation based on the angular velocity and the estimated inclination angle of the rotation system.

4. The sensor apparatus according to claim 3, wherein
the particular orientation is a true north or a true south.

5. The sensor apparatus according to claim 1, wherein
an angle formed by the axis of the accelerometer and the rotation axis is a value between a first value and a second value, the first value being a value of “μ” that gives a local minimum value of
$$“ C = {( \frac{2 {σ}_{e}}{sin μ} )}^{2} + {{η}_{1}^{2} ( \frac{{E}_{a μ}}{cos μ} )}^{2} ”$$
and the second value being a value of “μ” that gives a local minimum value of
$$“ C = {( \frac{2 {σ}_{e}}{sin μ} )}^{2} + {{η}_{2}^{2} ( \frac{{E}_{a μ}}{cos μ} )}^{2} ” ,$$
wherein
“η₁” is an expected minimum value of the inclination angle of the rotation system,
“η₂” is an expected maximum value of the inclination angle of the rotation system,
“σₑ” is an effective noise of the accelerometer, and
“E_{aμ}” is an expected remaining bias of the accelerometer.

6. The sensor apparatus according to claim 5, wherein
the first value is 61 degrees, and
the second value is 7 degrees.

7. An integrated circuit provided on the sensor apparatus according to claim 6, wherein the gyroscope and the accelerometer are integrated into a single chip.

8. A sensor module comprising:
a package in which the integrated circuit according to claim 7 is provided, and
a mechanism capable of attaching the package to the rotation system.

9. An inclination estimation method comprising:
rotating a rotation system around a rotation axis, the rotation system being provided with an accelerometer having an axis that is not parallel to either a plane perpendicular to the rotation axis or the rotation axis;
acquiring an acceleration measured by the accelerometer in response to rotation angles of three or more points of the rotation system rotated; and
separating the acceleration into a first component that follows the rotation of the rotation system and a second component that does not follow the rotation of the rotation system, and estimate an inclination angle of the rotation system based on the first component and the second component.

10. An orientation detection method comprising:
rotating a rotation system on which a gyroscope and an accelerometer are provided around a rotation axis, the gyroscope having an axis parallel to a plane perpendicular to the rotation axis of the rotation system, and the accelerometer having an axis that is not parallel to either the plane perpendicular to the rotation axis or the rotation axis;
acquiring, in response to rotation angles of three or more points of the rotation system rotated, an angular velocity measured by the gyroscope and an acceleration measured by the accelerometer;
separating the acceleration into a first component that follows the rotation of the rotation system and a second component that does not follow the rotation of the rotation system;
estimating an inclination angle of the rotation system based on the first component and the second component; and
estimating an azimuth of a particular orientation based on the angular velocity and the estimated inclination angle of the rotation system.
